(19) United States
(12) Patent Application Publication
(10) Pub. No.: US 2011/0150426 A1
(43) Pub. Date: Jun. 23, 2011

(54) SYSTEM AND METHOD FOR ACTIVELY MANAGING PLAY BACK OF DEMO CONTENT BY A DISPLAY DEVICE BASED ON DETECTED RADIO FREQUENCY SIGNALING

(75) Inventors: Peter Shintani, San Diego, CA (US); Brant L. Candelore, San Diego, CA (US)

(73) Assignees: SONY CORPORATION, Tokyo (JP); SONY ELECTRONICS INC., Park Ridge, NJ (US)

(21) Appl. No.: 12/643,870

(22) Filed: Dec. 21, 2009

(51) Int. Cl. H04N 5/91; G08B 21/00; H04B 7/00; H04N 9/80; H04N 5/76

(52) U.S. Cl. 386/250; 340/686.6; 455/41.2; 386/299

(57) ABSTRACT

An embodiment of the invention involves an apparatus, method and software for automatically controlling periodic play back of demo content. The apparatus comprises a memory, a radio detection logic and a processor. The radio detection logic is configured to detect a first radio frequency signal within a prescribed frequency range and to generate a control signal in response to detection of the first radio frequency signal. Coupled to the radio detection logic, the processor is configured to permit play back of a first type of content for a first time period upon receipt of the control signal where the first type of content is played back in lieu of playing back a second type of content that is normally processed for play back by the processor, to permit play back of the second type of content for a second time period after the first time period has elapsed. According to one embodiment, this play back occurs regardless if a second radio frequency signal within the prescribed frequency range is detected by the radio detection logic during the second time period, and the processor plays back the first type of content after the second time period has elapsed and the second radio frequency signal is detected. Other embodiments are described and claimed.

### FIELD

The invention generally relates to the field of consumer electronics. More particularly, one and more embodiments of the invention relate to a display device and method for actively managing play back of demo content, especially within a non-assisted commercial environment, by interrupting play back of streaming advertising content for stored demo content in response to detecting radio frequency (RF) signaling within a prescribed frequency range.

### BACKGROUND

Over the last decade, the purchasing experience for televisions and other consumer electronics has changed dramatically. Previously, consumer electronic retailers provided “assisted” commercial environments in which store personnel were trained to explain differences between competing consumer electronic products. In the sale of televisions for example, store personnel were given access to remote controls for each type of television on display. By having access to the remote controls, the store personnel were able to place the television into a various modes of operation in order to explain certain features and better respond to certain inquiries raised by customers.

As an example, if a customer was interested in a particular consumer electronic product such as a flat panel television, store personnel had access to the remote control associated with that particular television on display. The store personnel could turn on the television, could explain the capabilities of the television to the customer, and could place the television into a demo mode in order to illustrate features of this television. In many cases, the information provided by the store personnel and/or the content displayed during demo mode sufficiently explained why a particular television was better than other televisions in the marketplace. Then, the customer was provided more detailed information concerning prized features of the television, and thus, was better able to make an educated decision as to which television to purchase than simply purchasing the less expensive television.

Unfortunately, over the last decade, the purchasing environment has changed from an “assisted” commercial environment to a “non-assisted” commercial environment that are used by big-box retailers such as COSTCO®, SAM'S CLUB®, WALMART® and the like. In a “non-assisted” commercial environment, a big-box retailer typically places a number of consumer electronic products in the same general location.

As an illustrative example, where the consumer electronic products are flat panel televisions, the flat panel televisions are arranged in a display to prevent the customer from having physical access to the front or side control panels of these televisions. More specifically, the flat panel televisions are elevated above and recessed away from the aisle walkway so that the customer can see the displays and bezels of the flat panel televisions, but he or she is discouraged from accessing their control panels. Also, placement of the televisions behind boxed televisions mitigates the likelihood of a customer accessing the control panel of a selected television.

For these big-box retailers, all of the televisions are tuned to an in-store channel that provides streaming advertising content. However, the advertising content does not provide content which highlights features of any particular television in order to assist the customer in his or her purchasing decision. Rather, the advertising content is a series of ads, normally not in high-definition, that promote various television shows and encourage the purchase of other products or services provided by the big-box retailer. As a result, in this non-assisted commercial environment, customers tend to have difficulties in discerning the capabilities of televisions when simply viewing the displayed advertising content.

As an illustrated example, the streaming advertising content provided over the in-store channel may be slow-moving images provided over standard definition or high-definition programming with minimum resolution (e.g., 720 p supports a resolution of 1280×720 and a frame rate of 24 hertz “Hz”). As a result, when viewing the in-store advertising content, customers will have difficulty in noticing differences in picture clarity between the televisions on display, unlike the situation where the televisions are displaying high-resolution video of fast-paced sporting events, such as hockey or NASCAR for example. For this type of content, 1080 p televisions that support higher resolution video, motion interpolation and/or higher refresh rates (e.g., rates ≧120 Hz) will likely provide better picture quality than the lower priced 720 p televisions that only support up to a 60 Hz refresh rate.

It would be advantageous to the customers to allow manufacturers to showcase features of their electronic devices through play back of a demo without substantially interrupting the streaming of the advertising content used as a revenue base by the big-box retailer. Additionally, it would be advantageous for the activation of the demo to be predicated on radio frequency (RF) signaling from a device that many customers already possess.

### BRIEF DESCRIPTION OF THE DRAWINGS

Embodiments of the invention may best be understood by referring to the following description and accompanying drawings that are used to illustrate embodiments of the invention.

FIG. 1 is an exemplary embodiment of one or more display devices displayed for sale in a non-assisted commercial environment.

FIG. 2 is an exemplary embodiment of an optical sensor implemented with a display device of FIG. 1.

FIG. 3A is an exemplary embodiment of a display device illustrated in FIG. 1 that supports an enhanced demo mode.

FIG. 3B is a second exemplary embodiment of a display device illustrated in FIG. 1 that supports the enhanced demo mode.

FIG. 3C is a third exemplary embodiment of a display device illustrated in FIG. 1 that supports the enhanced demo mode.

FIG. 4A is an illustrative embodiment of a screen display generated by a display device of FIG. 3A for placing the display device into a Retail operating mode.

FIG. 4B is an illustrative embodiment of a screen display generated by a display device of FIG. 3A for placing the display device into an operating mode that supports demos.

FIG. 4C is an illustrative embodiment of a screen display generated by a display device of FIG. 3A for selecting a particular demo supported by the display device.

FIG. 5 is a first exemplary embodiment of the operations conducted by the display device of FIG. 3A operating in the Enhanced Demo mode.

FIG. 6 is a second exemplary embodiment of the operations conducted by the display device of FIG. 3A operating in the Enhanced Demo mode.

### DETAILED DESCRIPTION

Herein, for the purposes of explanation, numerous specific details are set forth in order to provide a thorough understanding of the invention. It will be apparent; however, to one skilled in the art that the invention may be practiced without some of these specific details. In addition, the following description provides examples, and the accompanying drawings show various examples for the purposes of illustration. However, these examples should not be construed in a limiting sense as they are merely intended to provide examples of embodiments of the invention rather than to provide an exhaustive list of all possible implementations. Also, in some instances, well-known structures and devices are not shown in block diagram form in order to avoid obscuring the details of the disclosed features of various described embodiments.

In the following description, certain terminology is used to describe certain features of the invention. For instance, the term “communication link” is generally defined as an information-carrying medium that establishes a communication pathway. Examples of the medium include a physical medium (e.g., electrical wire, optical fiber, cable, bus traces, etc.) or a wireless medium (e.g., air in combination with wireless signaling technology).

The term “demo content” is displayable and/or auditory information that is intended for play back on a device (e.g., display device) in order to highlight the features of that device. In contrast, “advertising content” is displayable and/or auditory information for play back on a device, where the information is intended to advertise particular goods and/or services and does not pertain to the device itself.

A “display device” is generally defined as an electronic device with display capabilities and radio frequency (RF) detection logic. Such display capabilities may range from an electronic device having an integrated display to an electronic device having no integrated display screen, but featuring one or more connectors that can be connected to route displayable content to an external display screen. Examples of a display device include, but are not limited or restricted to a flat panel television (e.g., cathode ray tube “CRT”, liquid crystal display “LCD”, plasma, organic light-emitting diode “OLED”, or any television with another type of display technology), a computer, a video game console, a handheld device (e.g., netbook, cellular phone, personal digital assistant “PDA,” etc.), an optical disk drive device, or the like.

At a minimum, the “RF detection logic” is a receiver that is adapted to measure signal strength (e.g., in decibels) of surrounding RF signals. According to one embodiment of the invention, RF detection logic does not decode the RF signal, but merely measures the signal strength by assigning a Radio Signal Strength Indication (RSSI) value to a detected RF signal. If the RSSI value is above a predetermined threshold, the RF detection logic notifies the processing logic to play back demo content if a mandatory pause is not in effect. Alternatively, according to another embodiment of the invention, the RF detection logic may include a decoder that receives the RF signal (e.g., text message over cellular frequencies or Bluetooth® signaling) and decodes the RF signal to recover the data within the RF signal.

The RF detection logic may be dedicated logic implemented within the display device or resident logic that is configured to perform RF signal detection operations only when the display device is placed into a certain operational mode. For instance, where the display device is a television, the operations of the RF detection logic may be performed by a television tuner, where the tuner is not used when the television is placed into Enhanced Demo mode in a Retail operational mode as described below.

The term “logic” is generally defined as hardware and/or software configured to perform one or more functions. One example of a certain type of logic is a processor, a programmable circuit or an application specific integrated circuit (ASIC) that is designed to process signals for rendering content for display. The content may include graphics, images, images or video with or without audio. Another example of a certain type of logic is software, which is generally describes as a series of executable instructions in the form of an application, an applet, or even a routine. The software may be stored in any type of machine readable medium such as a programmable electronic circuit, a semiconductor memory device such as volatile memory (e.g., random access memory, etc.) and/or non-volatile memory such as any type of read-only memory (ROM) or flash memory, a portable storage medium (e.g., Universal Serial Bus “USB” drive, optical disc, digital tape), or the like.

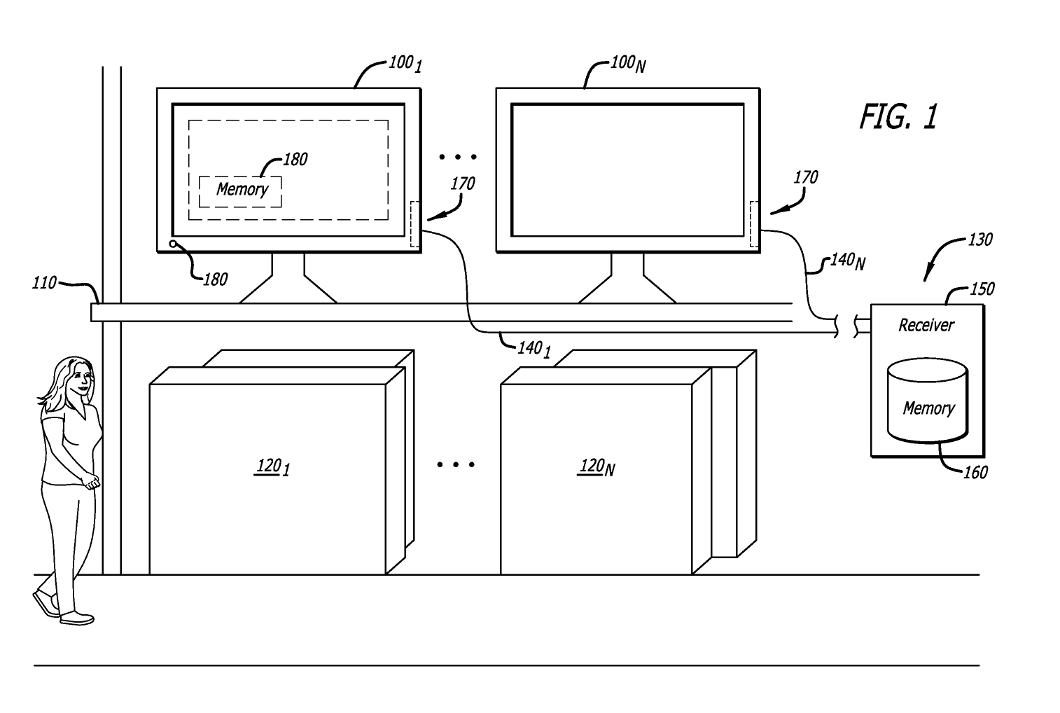

Referring to FIG. 1, an exemplary embodiment of multiple display devices residing in a non-assisted commercial environment is shown. According to this embodiment of the invention, display devices 100₁-100_{N} (N≧2) are placed on a storage rack 110 in order to elevate these devices above an aisle walkway, and in some situations, are placed behind boxed versions 120₁-120_{N} of these display devices bordering the walkway. This environment, which promotes the separation of display devices 100₁-100_{N} from a customer and prevents the customer from altering the operating states of display devices 100₁-100_{N}, is referred to as a “non-assisted commercial environment,” namely a retail environment that does not encourage physical interaction with or testing of the display device by the customer before purchase.

Herein, all of display devices 100₁-100_{N} are in communication with a content forwarding system 130 via communication links 140₁-140_{N} and are tuned to the same in-store channel. According to one embodiment of the invention, content forwarding system 130 includes a receiver 150 that receives streaming advertising content, such as a series of displayable advertisements, from a remote source (not shown). Receiver 150 may be configured to receive advertising content transmitted via satellite, optical or wired lines, wireless or the like. The transmitted advertising content is stored in memory 160 of receiver 150. The stored advertising content is subsequently transmitted as a continuous stream of data to each display device 100₁, . . . , and 100_{N}. The advertising content may be routed as YPbPr and baseband audio, although other analog or digital transmission schemes may be used. Of course, the advertising content may be transmitted via an HDMI port upon receipt and without prolonged or any storage within memory 160.

Besides receiving advertising content via a remote source, one or more display devices (e.g., at least display device 100₁) may be adapted to receive uploaded information, such as software, a demo configuration file or demo content, via a secondary communication port. For instance, display device 100₁ may include one or more connectors 170, being any type of input/output (I/O) connectors such as a USB connector onto which a USB drive may be coupled, in order to upload the demo content and a demo configuration file that lists the particular portions forming the demo content. The demo content may be displayed by display device 100₁ when it is operating in an Enhanced Demo mode and detects an RF signal within a prescribed frequency range. The RF signal may originate from a handheld device that can emit RF signals such as a cellular telephone, a remote keyless system (e.g., a key fob, keylike transducer, etc.) or the like.

According to one embodiment of the invention, where the RF signals are emitted from a remote keyless system, the prescribed frequency range may be between 300-350 mega-hertz (MHz) in North America and Japan, or between 400-450 MHz in Europe. Where the RF signals constitute a text message sent from a cellular phone, the frequency range depends on the communication standard supported by the logic within the cellular telephone. For instance, GSM 850 and CDMA 850communication protocols are directed to a frequency range between 869 MHz-894 MHz. GSM 1900 and CDMA 1900 communication protocols are directed to a frequency range between 1930 MHz-1990 MHz. Of course, it is contemplated that these frequency ranges may differ from country to country and the frequency range may be selected as any detectable frequencies in order to cause the triggering of a play back of the demo content.

More specifically, display device 100₁ may be configured to operate in one of two operational states: Home and Retail. For instance, when operating in the “Home” operational state, display device 100₁ may be configured to take greater advantage of power saving features, such as activating a presence sensor, such as an “ECO™ sensor” for SONY® BRAVIA® televisions, that is adapted to power-down display device 100₁ if no movable objects are sensed in front of display device 100₁ for a prescribed period of time. More pertinent to the invention, however, display device 100₁ may be placed in the “Retail” operational state, which features two selectable modes; namely, Normal mode or Enhanced Demo mode.

In Normal mode, display device 100₁ receives content from content forwarding system 130 and simply displays such content. However, when placed in Enhanced Demo mode, display device 100₁ activates (or reconfigures) the RF detection logic so that display device 100₁ continues to display the streaming advertising content without interruption. However, upon detecting RF signals within a prescribed frequency range being emitted in front of display device 100₁, display device 100₁ now starts to display the demo content.

Furthermore, display device 100₁ executes software, retrieved from internal memory or from a portable storage medium coupled to USB connector 170, which causes display device 100₁ to monitor for RF signals within a prescribed frequency range. Upon detecting such RF signals, display device 100₁ temporarily interrupts the display of the advertising content received by its HDMI or other communication port via communication link 140₁. During this interruption, the demo content, which has been either previously uploaded into internal memory 180 at manufacture or during initialization or is currently stored in portable storage medium coupled to connector 170, is played back for display in order to highlight certain features of display device 100₁.

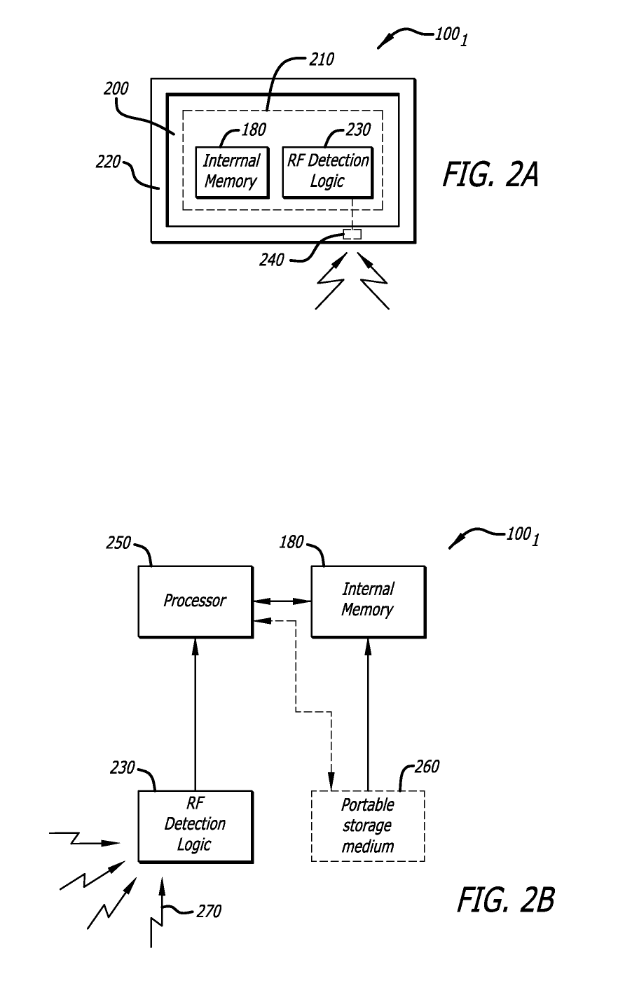

Referring to FIG. 2A, a first exemplary embodiment of a display device 100₁ that supports an Enhanced Demo mode is shown. According to this embodiment of the invention, display device 100₁ is a flat panel television that features a screen 200, a rear casing 210 and a bezel 220. Rear casing 210 houses internal memory 180, a backlight (not shown), processing circuitry and other logic that controls the operation of display device 100₁. Bezel 220 is situated to surround and partially overlay the perimeter of screen 200. According to one embodiment of the invention, RF detection logic 230 is implemented within rear casing 210 of display device 100₁ with an antenna 240 associated with the RF detection logic 230 placed either within rear casing 210 or external to rear casing 210 as shown. Of course, in lieu of placing RF detection logic 230 within rear casing 210, it is contemplated that RF detection logic 230 may be partially housed by bezel 220 with a portion of RF detection logic 230, such as the antenna for example, being exposed outside an outer surface of bezel 220.

Referring now to FIG. 2B, an exemplary embodiment of components implemented within display device 100₁ of FIG. 2A and utilized when display device 100₁ is placed in Enhanced Demo mode is shown. Herein, display device 100₁ comprises RF detection logic 230, a processor 250 and internal memory 180. More specifically, when display device 100₁ is placed in Enhanced Demo mode, RF detection logic 230 continuously or periodically monitors for a RF signal 270 within a prescribed frequency range, measures signal strength of RF signal 270, and assigns an RSSI value to that RF signal. RF detection logic 230 may include a unidirectional antenna so that the detected RF signal is originating in front of display device 100₁.

Upon detecting the RF signal, RF detection logic 230 sends a signal, namely a RF Detection signal, to processor 250 to execute logic for play back of the demo content that is stored in internal memory 180. Alternatively, as represented by dashed lines, the executed logic may be stored within a portable storage medium 260 (e.g., USB drive) or processor 250 may fetch the demo content, such as one or more pre-stored video clips, from portable storage medium 260.

As an illustrative example, when placed in Enhanced Demo mode, display device 100₁ activates RF detection logic 230 that continuously or periodically scans for RF signals within the prescribed frequency range. As an option, RF detection logic 230 may be directional to only detect these RF signals originating in front of display device 100₁. Concurrently with the activation of RF detection logic 230 and in response to placement of display device 100₁ into Enhanced Demo mode, a text message may be generated by processor 250 to overlay the streaming advertising content being rendered. The text message invites a customer to activate a handheld device (e.g., a remote keyless system such as a key fob or key with remote entry) that causes an emission of an RF signal with a prescribed frequency range. Upon detection of the RF signal, RF detection logic 230 signals processor 250 within display device 100₁ to immediately play back the demo content. Alternatively, processor 250 may cause another text message to be generated to overlay the streaming advertising content, where the second text message requests the customer to activate the handheld device again and cause a second emission of RF signals. The second text message is to ensure that a customer wants display device 100₁ to display the demo content, and the RF transmission was not coincidental to the display of the first text message.

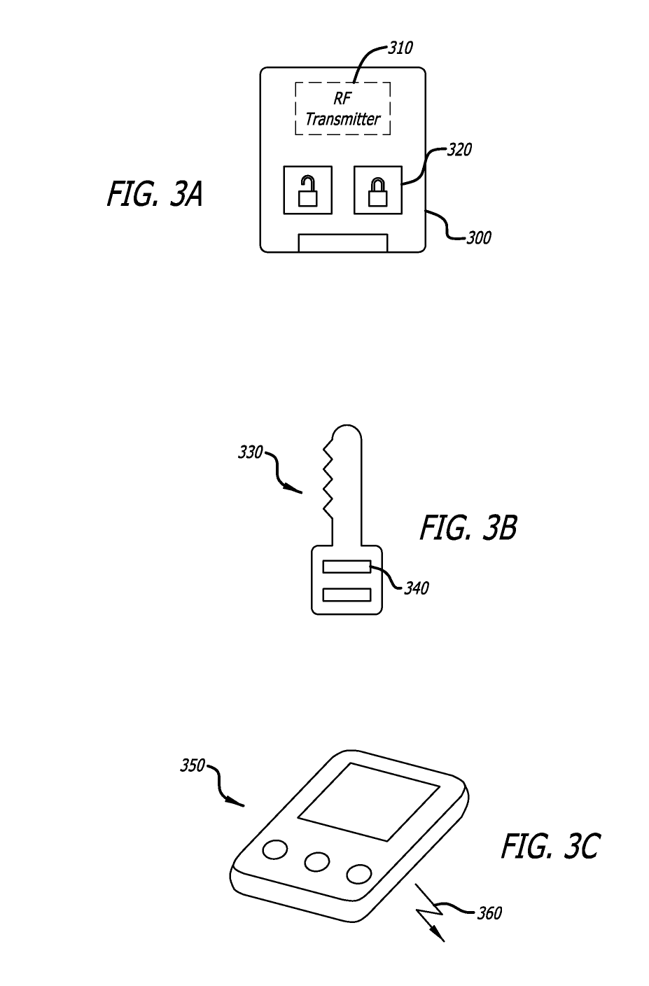

Referring to FIG. 3A-3C, illustrative embodiments of handheld devices for controlling the emission of RF signals is shown. Herein, a first handheld device 300 is a key fob that supports wireless signal transmissions and comprises a RF transmitter 310. According to one embodiment of the invention, RF transmitter 310 emits an RF signal in response to depressing a particular button 320 (e.g., car door lock) on handheld device 300. Such RF transmissions may be in accordance with a frequency range that is reserved for the transmission of RF signals for controlling access to an interior of a vehicle, building or the like. Of course, in lieu of transmitting RF signals in response to depression of button 320, it is contemplated that key fob 300 may be a transducer that continuously transmits RF signals at the prescribed frequency. These key fobs are used for automobiles with push-button ignitions.

According to another embodiment of the invention, as shown in FIG. 3B, a second handheld device 330 may be a car key that features a button 340 that, when depressed, transmits a RF signal within the prescribed frequency range to signal the display device to play back the demo content. Yet another embodiment of the invention, as shown in FIG. 3C, a third handheld device 350 may be a cellular telephone that transmits Bluetooth® signaling 360 which may be detected by RF detection logic 230.

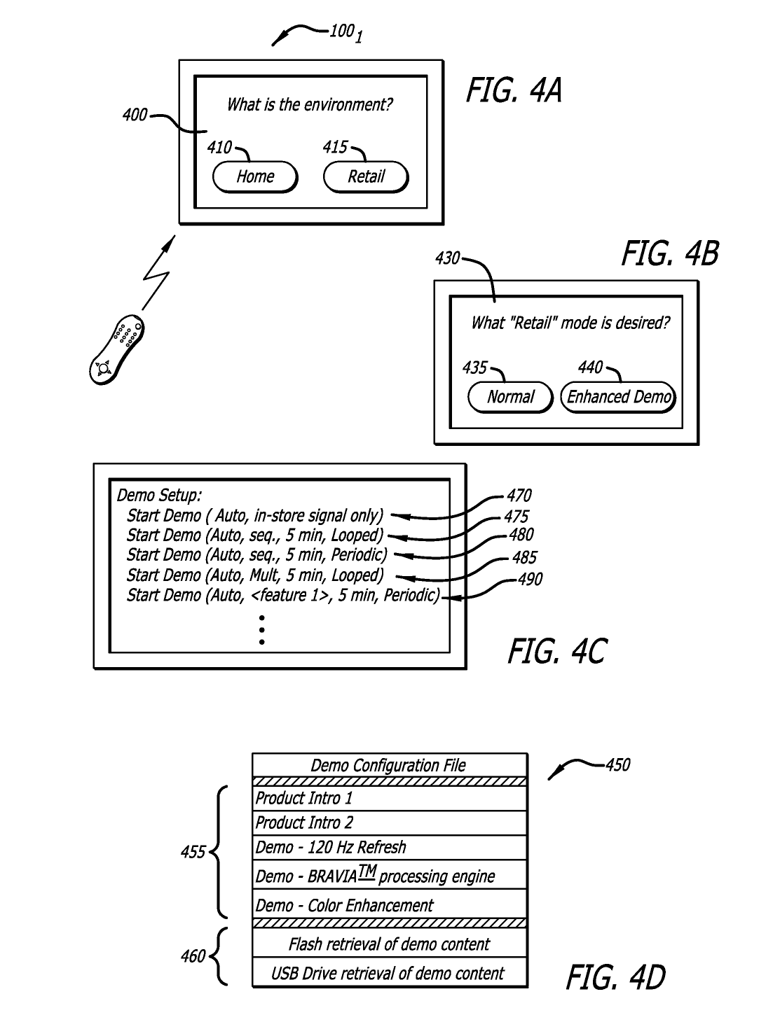

Referring to FIG. 4A, an illustrative embodiment of a screen display generated by display device 100₁ of FIG. 2A for placing display device 100₁ into the Retail operational state is shown. Herein, according to one embodiment of the invention, upon initial power-up, display device 100₁ displays an initialization screen display 400. Initialization screen display 400 allows the user to select a current operating state for display device 100₁ by selecting one of a plurality of option buttons 410 and 415. A first option button 410, if selected, places display device 100₁ into the Home operational state. A second option button 415, if selected, places display device 100₁ into the Retail operational state.

After selecting second option button 415 and placing display device 100₁ into the Retail operational state, a secondary screen display 430 is rendered as shown in FIG. 4B. Secondary screen display 430 illustrates what types of Retail operating modes are available and allows the user to select one of a plurality of option buttons 435 and 440 rendered on a screen of display device 100₁. A first option button 435 represents a Normal mode in which display device 100₁ operates to merely play back or display the advertising content received over one of its communication ports such as HDMI port, a YPbPr port and the like. A second option button 440 represents an Enhanced Demo mode, which causes activation of RF detection logic and other logic dedicated in supporting demo operations of display device 100₁ in Enhanced Demo mode.

More specifically, according to one embodiment of the invention, logic for supporting demo operations (hereinafter referred to as “demo-control logic”) is uploaded into internal memory (e.g., non-volatile memory such as flash or battery backed-up random access memory) within display device 100₁ during manufacture. In response to selecting second option button 440, the demo-control logic is retrieved and executed by the processor. Execution of the demo-control logic causes activation of the RF detection logic to detect and measure RF signal strength and assign an RSSI value to that detected RF signal.

When the detected RF signal is within a prescribed frequency range and is above a predetermined RSSI threshold (collectively referred to as a “RF triggering event”), display device 100₁ fetches the demo configuration file and the demo content from internal memory. Herein, the demo content is stored with corresponding control information that identifies the type of demo content uploaded. For instance, the control information may identify the demo content to be one of a number of content types, such as graphics (text), graphics (text) with audio, images, images and audio, or video for example. The control information is fetched along with the demo content and may be used by display device 100₁ to determine behavioral characteristics of display device 100₁.

Alternatively, the control information may be stored as part of the demo content. For instance, the demo content may be separated into definable segments (e.g., frames, cells, etc.) with each segment featuring a header portion that includes content type. The content type information is used by display device 100₁ to determine behavioral characteristics of display device 100₁.

FIG. 4C is an illustrative embodiment of a screen display generated by a display device of FIG. 2A for placing display device 100₁ into one of a plurality of Enhanced Demo modes is shown. Herein, display device 100₁ is placed in the Enhanced Demo mode and, upon placement into this mode, display device 100₁ accesses the demo configuration file to identify and subsequently display the number of demo options available to the retailer as provided by the demo configuration file. For instance, as shown in FIG. 4D, demo configuration file 450 may feature demo video clips 455 that are directed to explanation of display device 100₁ as a whole (Product Intro) or particular features of display device 100₁. Also, demo configuration file 450 may include fields 460 to direct display device 100₁ to fetch and display other demo content from internal memory therein or from the portable storage medium.

Referring back to FIG. 4C, upon accessing the demo configuration file, display device 100₁ displays a plurality of demo options available to the retailer. The retailer is able to select one or more of these demo options, and based on the selection, play back these demo video clip(s) in response to detection of a RF triggering event. The manner of such play back may be “periodic” or “looped”. Periodic play back means that a series of demo video clips (e.g., one or more demo video clips) are played back and followed by at least a predetermined amount of time for play back of the streaming advertising content. According to one embodiment, the amount of time for playback of the streaming advertising content may be static or adjusted by the retailer, normally from zero minutes (immediate looped playback) and multiple minutes. The play back duration of the demo video clips does not to exceed two minutes for each detected RF triggering event. Looped play back means that, in response to detecting a RF triggering event, one or more demo video clips may be displayed successively with play back of streaming advertising interspersed between the demo video clips.

For instance, upon selection of a first demo option 470, only the in-store advertising content is used by display device 100₁ for demo purposes. However, upon selection of a second demo option 475, the display device automatically plays back one or more demo video clips in a looped play back manner, namely each demo video clip is directed to a different feature and a predetermined interval (e.g., five minutes) is required between the display of each demo video clip. The “predetermined interval” is a mandatory time period (pause) in which demo content is precluded from being displayed and only in-store advertising content is allowed to be displayed even if RF triggering events are detected.

Third demo option 480 involves the display device automatically playing back a video clip in a periodic play back fashion, where a demo video clip is played back followed by a predetermined interval (e.g., five minutes) for display of the streaming advertising content. After the predetermined interval, if another RF triggering event is detected, display device 100₁ is permitted to play back the demo content which may involve the same or different demo video clips.

If selected, a fourth demo option 485 involves the display of multiple demo video clips forming the demo content in a looped play back fashion with a predetermined interval interposed between the multiple demo video clips. Each demo video clip being directed to a different feature for display device 100₁. In contrast with second demo option 480 that involves a serial display of demo video clips, it is noted that multiple demo video clips are shown in between each predetermined interval.

A fifth demo option 490 involves the display in a periodic play back fashion of a demo video clip that is directed to a single feature of display device 100₁ and at least the predetermined interval is required after each display of the demo video clip. For instance, the demo video clip may be directed to a particular feature such as the processing engine used by display device 100₁. Herein, upon detection of a RF triggering event, the demo video clip directed to the processing engine is played back, and thereafter, the predetermined interval is required. Thereafter, if another RF triggering event is detected, the demo video clip directed to the processing engine is played back again. During the predetermined interval, according to one embodiment of the invention, no graphics (e.g., text message) or audio instructing viewers as how to activate play back of the demo content is provided.

It is contemplated that, where the demo content is stored in flash memory, repeated accesses to flash memory may cause the lifetime of the flash to be reduced, and hence, the lifetime of the television may be reduced as well. One possibility to mitigate this issue is to copy the demo content into random access memory (RAM) and to read the demo content from RAM instead of flash memory. On boot, where the display device is a television, it already copies television software from flash memory to RAM. The television would need to do this for the demo content as well.

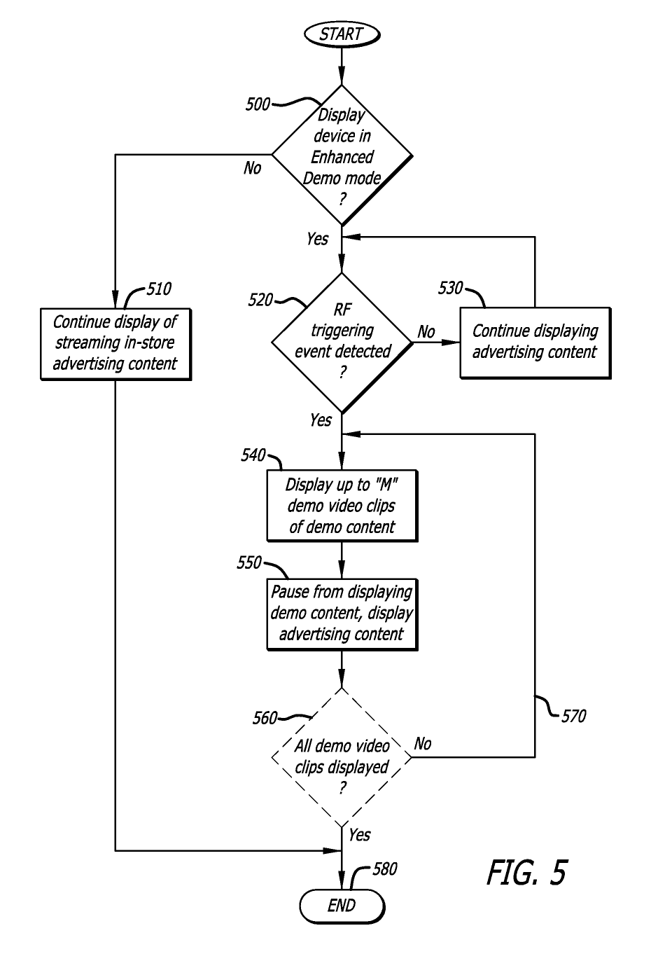

FIG. 5 is a first exemplary embodiment of the operations conducted by the display device of FIG. 2A operating in the Enhanced Demo mode. Initially, a determination is made whether the display device has been placed into Enhanced Demo mode (item 500). If not, the in-store advertising content is merely shown by the display device (item 510). However, if the display device has been placed into Enhanced Demo mode, a determination is made whether an RF triggering event has been detected (item 520).

If a RF triggering event is not detected, namely an RF signal within a prescribed frequency range is not detected, the display device simply continues to monitor for an RF triggering event (item 530). The streaming advertising content continues to be displayed at this time. However, if an RF triggering event is detected, the display device executes logic that causes demo content to be displayed in order to showcase attributes for the display device (item 540). The demo content may be “M” demo video clips (M≧1), each corresponding to an attribute to be displayed before discontinuing the display of demo content and requiring in-store advertising content to be displayed for a predetermined interval. In other words, after displaying “M” demo video clip(s), a mandatory pause for the predetermined duration is required by the display device in order to ensure that the demo content is interspersed with the advertising content streamed into the display device (item 550). Thereafter, as an optional feature, a determination may be made as to whether demo video clips for all of the attributes associated with the selected demo content have been shown (item 560). If not, the display device continues to cycle through the remaining demo video clips forming the demo content (item 570). Otherwise, the operations conducted by the display device in response to an RF triggering event cease (item 580).

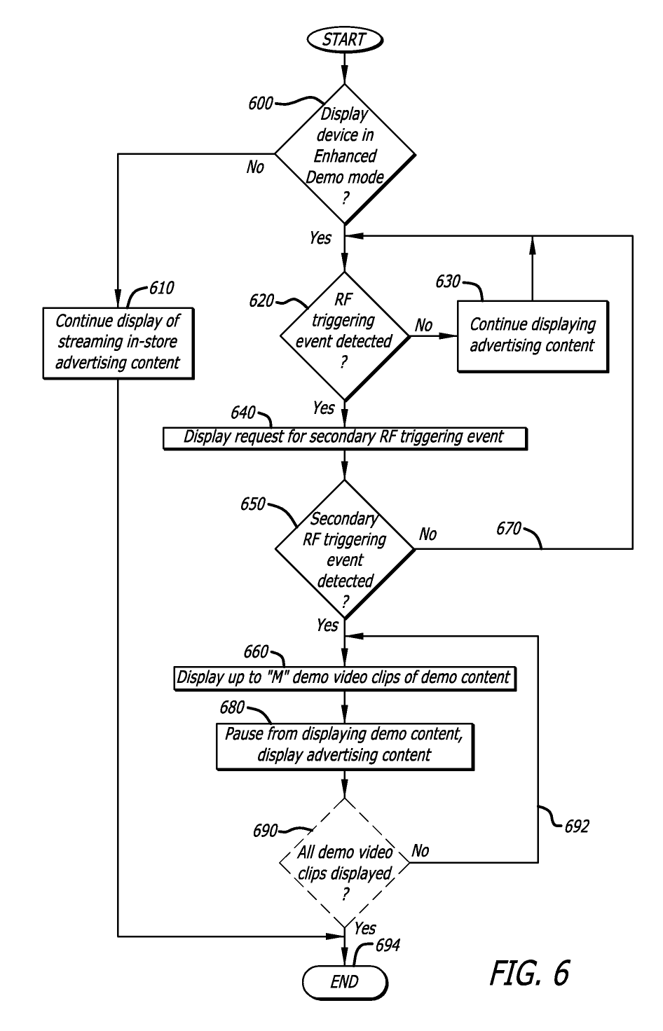

FIG. 6 is a second exemplary embodiment of the operations conducted by the display device of FIG. 2A operating in the Enhanced Demo mode. Initially, a determination is made whether the display device has been placed into Enhanced Demo mode (item 600). If not, the in-store advertising content is merely shown by the display device (item 610). However, if the display device has been placed into Enhanced Demo mode, a determination is made whether an RF triggering event has been detected (item 620).

If an RF triggering event is not detected, the display device simply continues to monitor for an RF triggering event and the streaming advertising content continues to be displayed (item 630). However, if the RF triggering event is detected, the display device executes logic that causes displayable information (e.g., a text message, an image, etc.) to be displayed to request the customer to perform a secondary RF triggering event in order to confirm that the customer requests a demo (item 640). The secondary RF triggering event may be the same or different from the initial RF triggering event.

If the secondary RF triggering event is detected prior to time-out, namely a time interval during which the display device monitors for the secondary RF triggering event, the demo content is displayed in order to showcase attributes for the display device (items 650 and 660). The demo content may be “M” demo video clips, which correspond to the number “M” of attributes to be displayed before requiring a predetermined interval for display of in-store advertising content. Otherwise, the display device returns to monitor for an initial RF triggering event (item 670).

After displaying these demo attributes, a mandatory pause for the predetermined invention is conducted by the display device in order to prevent cycling of the demo content and to ensure that the demo content is interspersed with the advertising content provided streamed into communication ports of the display device (item 680). Thereafter, as an optional feature, a determination may be made as to whether demo video clips for all of the attributes associated with the selected demo content have been shown (item 690). If not, the display device continues to cycle through the remaining demo video clips (item 692). Otherwise, the operations conducted by the display device in response to the secondary RF triggering event cease (item 694).

Having disclosed exemplary embodiments and the best mode, modifications and variations may be made to the disclosed embodiments while remaining within the scope of the embodiments of the invention as defined by the following claims.

What is claimed is:

1. A method for automatically controlling a display device to periodically play back demo content, the method comprising:
receiving streaming advertising content for play back;
monitoring for a triggering event by detection logic within the display device, the triggering event being a radio frequency signal in a prescribed frequency range;
automatically playing back the demo content for a first period of time in response to detecting the triggering event;
halting play back of the demo content after the first period of time has elapsed; and
continuing to play back the streaming advertising content by the display device.

2. The method of claim 1, wherein the play back of the streaming advertising content by the display device for a second period of time occurs even if another triggering event is detected during the second period of time.

3. The method of claim 1, wherein the monitoring of the triggering event includes detecting the radio frequency signal generated by activation of a remote keyless system that is used to control operations of an automobile.

4. The method of claim 3, wherein the monitoring of the triggering event includes detecting the radio frequency signal generated by activation of the remote keyless system being a transducer that continuously emits the radio frequency signal to indicate proximity of a driver to the automobile.

5. The method of claim 3, wherein the monitoring of the triggering event includes detecting the radio frequency signal generated by activation of the remote keyless system being a key fob that emits the radio frequency signal to indicate proximity of a driver to the automobile upon depression of a button on the key fob.

6. The method of claim 1, wherein the monitoring of the triggering event includes detecting the radio frequency signal being a Bluetooth® signal generated by a cellular phone.

7. The method of claim 1, wherein the automatic playing back of the demo content for the first period of time includes displaying one or more video clips directed to features of the display device.

8. The method of claim 1, wherein the monitoring of the triggering event includes receiving a text message operating as the triggering event from a cellular phone.

9. The method of claim 1, wherein prior to automatically playing back the demo content for the first period of time, the method further comprises:
repeating to monitor for a second triggering event, and upon detecting of the second triggering event, the demo content is automatically played back.

10. An apparatus comprising:
a memory;
a radio detection logic to detect a first radio frequency signal within a prescribed frequency range and to generate a control signal in response to detection of the first radio frequency signal;
a processor coupled to the radio detection logic, the processor to (i) permit play back of a first type of content for a first time period upon receipt of the control signal where the first type of content is played back in lieu of playing back a second type of content that is normally processed for play back by the processor, (ii) permit play back of the second type of content for a second time period after the first time period has elapsed regardless if a second radio frequency signal within the prescribed frequency range is detected by the radio detection logic during the second time period, and (iii) play back the first type of content after the second time period has elapsed and the second radio frequency signal is detected.

11. The apparatus of claim 10, wherein the radio detection logic being a television tuner when the apparatus is placed in an Enhanced Demo mode.

12. The apparatus of claim 10, wherein the radio detection logic is configured to detect the radio frequency signal being a signal generated by activation of a remote keyless system that is used to control operations of an automobile.

13. The apparatus of claim 12, wherein the radio detection logic is configured to detect the radio frequency signal generated by activation of the remote keyless system, where the remote keyless system is a transducer that continuously emits the radio frequency signal to indicate proximity of a driver to the automobile.

14. The apparatus of claim 12, wherein the radio detection logic is configured to detect the radio frequency signal being a signal generated by activation of the remote keyless system, where the remote keyless system is a key fob that emits the radio frequency signal to indicate proximity of a driver to the automobile upon depression of a button on the key fob.

15. The apparatus of claim 10, wherein the radio detection logic is configured to detect the radio frequency signal being a Bluetooth® signal generated by a cellular phone.

16. The apparatus of claim 10, wherein the processor to permit play back of the first type of content for the first time period by automatically displaying one or more video clips being demo content in lieu of display of streaming advertising content being the second type of content.

17. The apparatus of claim 10, wherein the radio detection logic is configured to detect the radio frequency signal being a text message from a cellular phone.

18. A software stored within a memory and executed by a processor implemented within a display device being an electronic device with display capability, to perform the operations of:
monitoring for a triggering event during display of a streaming advertising content received from a remote source, the triggering event being a radio frequency signal within a prescribed frequency range;
automatically displaying a demo content uploaded in internal memory of the display device for a first predetermined period of time; and
continuing the display of the streaming advertising content by the display device after the first predetermined period of time has elapsed, the display of the streaming advertising content being for a second predetermined period of time being at least equal in duration to the first predetermined period of time.

19. The software of claim 18, wherein the operations of monitoring of the triggering event includes detecting the radio frequency signal that is generated by activation of a remote keyless system that is used to control operations of an automobile.

20. The software of claim 18, wherein the operations of monitoring of the triggering event includes detecting the radio frequency signal being a Bluetooth® signal generated by a cellular phone.

21. The software of claim 18, wherein the automatic displaying of the demo content for the first predetermined period of time includes displaying one or more video clips directed to features of the display device.
